(19) United States
(12) Patent Application Publication
(10) Pub. No.: US 2006/0242014 A1
(43) Pub. Date: Oct. 26, 2006

(54) Contacts networking technology

(76) Inventors: Charles T. Marshall, Atherton, CA (US); James Fan, Los Altos, CA (US)

Correspondence Address: PATENTS PENDING, 9832 LOIS STILTNER CT, ELK GROVE, CA, 95624, US

(21) Appl. No.: 11/113,430

(22) Filed: Apr. 25, 2005

(51) Int. Cl. G06Q 99/00; G07G 1/14; G06Q 30/00

(52) U.S. Cl. 705/14; 705/1

(57) ABSTRACT

A referral and recruitment system hosted on a webserver for recruitment, fundraising or advocacy campaigns. Users on the Internet with browsers are able to log-on as clients to post and refer charitable donations or job opportunities, for example. At the heart of the server is an incentive engine that tracks job openings by their ID, incentive type, and the value of the incentive. Incentives can be structured as cash bonuses, days off, contest points, etc. Combinations of incentives can be tailored to suit particular persons or groups. Users can post new jobs, make direct referrals to collect the entire hiring incentive, or pass along the information to their private contacts to share later in the incentives. The communication between these people is based on email and their respective email contact lists. The system tracks who-knows-who, and who-referred-who to who. The hierarchy of relationships can then be used to dictate how the incentive bonuses and payments are distributed amongst the successful referring parties. Employment opportunities can be broadcast to recruiting organizations. Each time an employee, friend, recruit or associate sets up a message campaign, or responds to a message, they do so from their own personalized account using their email address for user identification.

### BACKGROUND OF THE INVENTION

1. Field of the Invention

The present invention relates to contacts networking and incentive systems, and more particularly to automated candidate and prospect referral systems.

2. Description of Related Art

Very often the needs of an organization outstrip their abilities to find suitable candidates. This is true for employers trying to find qualified workers, for charitable organizations to find donors, for creditors to find debt-collection agents to get debtors to pay their bills, for researchers to find suitable clinical trial candidates, for law enforcement to find tipsters willing to respond to rewards, etc. So organizations have resorted in the past to the use of incentives and incentive programs that are not automated, difficult to administer, and limited in the populations they reach.

Many campaigns to find the needed resources are infrequent or rare events that do not justify a full-time, in-house staff. But at the same time, these campaigns demand high quality candidates that do not respond to traditional forms of marketing and advertising.

### SUMMARY OF THE INVENTION

Briefly, a referral and recruitment system embodiment of the present invention is hosted on a webserver and provides for recruitment, fundraising, or advocacy campaigns. Users on the Internet with browsers log-on as clients to post and refer charitable donations or job opportunities, for example. At the heart of the server is an incentive engine that tracks job openings or other offerings by their ID, incentive type, and the value of the incentive. Incentives can be structured as cash bonuses, days off, contest points, etc. Combinations of incentives can be tailored to suit particular persons or groups. Users can post new jobs, make direct referrals to collect the entire hiring incentive, or pass along the information to their private contacts to share later in the incentives. The communication between these people is based on email and their respective email contact lists. The system tracks who-knows-who, and who-referred-who to who. The hierarchy of relationships can then be used to dictate how the incentive bonuses and payments are distributed amongst the successful referring parties. Employment opportunities can be broadcast to recruiting organizations. Each time an employee, friend, recruit or associate sets up a message campaign, or responds to a message, they do so from their own personalized account using their email address for user identification.

An advantage of the present invention is a contact network is provided where each recipient who forwards, commits or responds in any way, sets up their own personalized account. Such allows sponsors to easily collect and track new email addresses and campaign data, thus creating a valuable re-contact and tracking tool.

Another advantage of the present invention is that a contact network is provided that automates and leverages Candidate Referral Programs. Messages are personal, dynamic, actionable, and customizable rich-text HTML emails which can include graphics, animation files, colors, and unique incentive management capabilities.

A still further advantage of the present invention is that a contacts networking technology is provided with individual account access for each participant, automated incentive creation and management, embedded email address manager, viral forwarding functionality, ability to automatically refer a candidate, resume storage and handling, directory service to locate current email addresses, real time referral tracking for all responses, multi-level organization admin features, auto non-duplicate email detection and handling, etc.

Another advantage of the present invention is that a contact network is provided that allows an employer, recruiter or sponsor to set up their own campaigns, e.g., naming the campaign, its duration, the position description or marketing message, etc. An administrator decides the starting and any ending dates of the campaign. If the employer wishes to include a bonus to encourage membership recruitment, they can select a rule from standard challenge rules provided, and then separately define the rule parameters.

A further advantage of the present invention is that a contact network is provided with incentive methods that include a direct bonus, where a one-time bonus is awarded to the person directly responsible for fulfilling the campaign goal, or allowing the referral agents to share the bonus, where users may elect to share all or part of the provided bonus with their contacts as incentive for campaign participation. Incentives can be structured in any units as defined by the employer within the application, e.g., dollars, time off, points, coupons, volunteer hours, etc.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of a contacts networking technology system embodiment of the present invention;

FIG. 2 is a functional block diagram of a PHP implementation of a part of the system in FIG. 1;

FIG. 3 is a dataflow diagram of a tracking engine useful in a recruiting incentive example of the system of FIG. 1;

FIG. 4 is a functional block diagram of an incentives engine useful in a recruiting incentive example of the system of FIG. 1;

FIG. 5 is a flowchart diagram a privacy process embodiment of the present invention; and

FIG. 6 is a flowchart diagram a shared incentive process embodiment of the present invention.

### DETAILED DESCRIPTION OF THE INVENTION

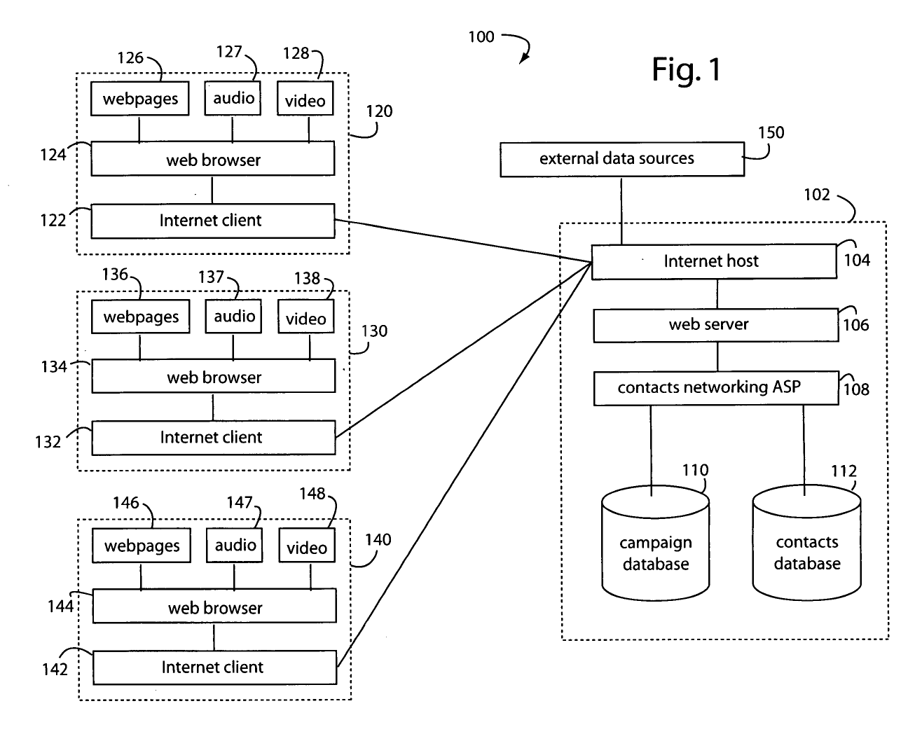

FIG. 1 illustrates a contacts networking technology system embodiment of the present invention, and is referred to herein by the general reference numeral 100. Such includes a viral email networking software platform to help participants of employee and member referral programs leverage their social, corporate and business community contacts. The contacts networking technology system 100 provides personalized individual account access for each participant. The system 100 comprises a business 102 with an Internet host 104, a web server 106, a contacts networking ASP or PHP application 108, and a database, e.g., a campaign database 110 and a contacts database 112. These two databases can be consolidated into one. The Internet host 104 is visible to a user 120 with an Internet client 122 and a web browser 124 able to interact with webpages 126, audio 127, and video media 128. Similarly, the Internet host 104 is accessible to an administrator 130 with an Internet client 132 and a web browser 134 able to interact with webpages 136, audio 137, and video media 138. The Internet host 104 is hyperlinked to a referral 140 with an Internet client 142 and a web browser 144 able to interact with webpages 146, audio 147, and video media 148. Such referral was not originally known to business 102, but was introduced by user 120 and can thereafter participate in campaigns and incentives. System 100 can limit email communications to particular domains.

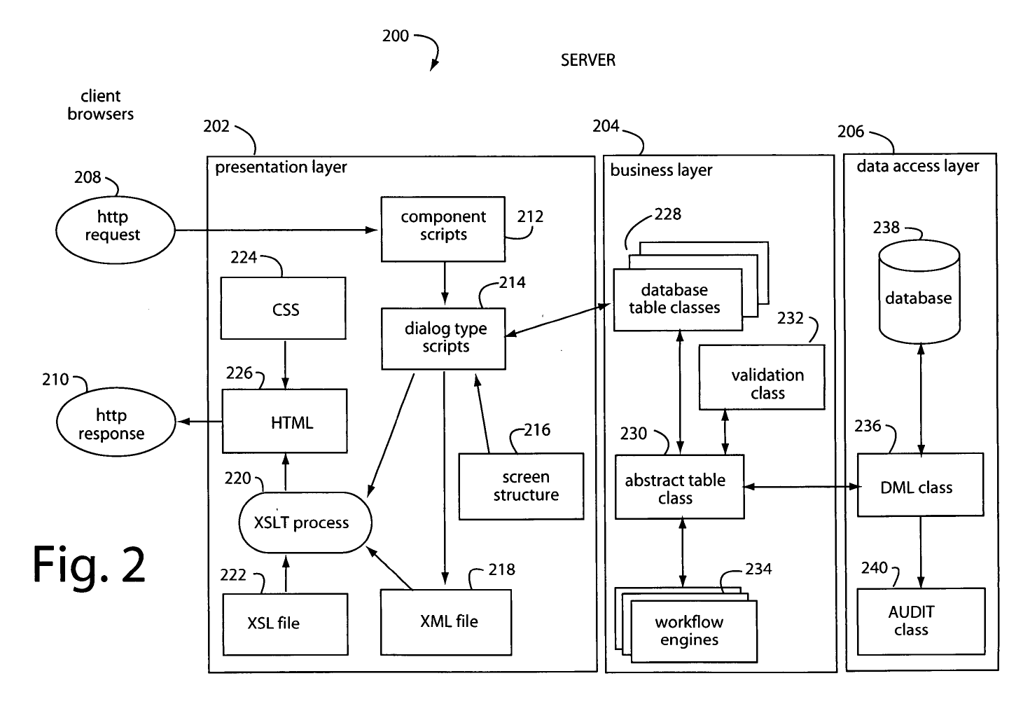

FIG. 2 represents a PHP-implementation 200 of a part of system 100 (FIG. 1). See, http://www.tonymarston.net/php-mysql/infrastructure.html#dml.class, by Tony Marston, ∓A Development Infrastructure for PHP, Sep. 16, 2004. Many other more conventional ways can be used to implement such, e.g., Active Server Pages (ASP), Java, etc. Here, such PHP-implementation 200 includes a three layer structure, e.g., a presentation layer 202, a business layer 204, and a data access layer 206. Webpage requests from the clients' browsers come in as hypertext transfer protocol (http) requests 208 and are answered with http responses 210.

The Business Layer does not own exclusive rights to the data access layer. The presentation layer may also access the database, e.g., when some data needs to be retrieved for display.

The Business Layer includes entities known as Packages. A Package is a Class that encapsulates a collection of related data and operations that may be performed on that data. For example, there is a Package Class that represents a user in the system. This class contains data regarding the user (name, address, job title, etc.) as well as operations that may be performed on this data, e.g., updating the name, updating the address, committing the changes to the database, etc.

Packages exist for every major type of entity in the system, e.g., users, organizations, campaigns, messages. They are simply in-memory representations of information from the database that may be manipulated by the contacts networking application and then committed to the database for permanent storage. Packages may be created from existing data. For example, when editing a user profile. Or they may be created anew, e.g., when creating a new user profile.

Packages serve as vessels that may be transmitted between various parts of the contacts networking application. Consider the following example: suppose we're dealing with the creation of a user account. The User Creation Workflow Engine (UCWE) creates a new UserPackage. As the UCWE progresses from step to step, it populates the UserPackage with information that is gathered at each step, possibly passing the UserPackage (or parts of it) to various Utility or Logic Engines for processing. Once the UCWE has reached the end of its operation, it then commits the UserPackage to the database for permanent storage. The UCWE and the UserPackage are then disbanded and the user is sent back to the login page so that they may sign on with their new account.

All business rules are processed by objects within the business layer 204. All interfacing with the user is done by components within the presentation layer 202. There is no direct communication between the presentation and data access layers. All communication must pass through the business layer 204. The presentation logic includes the user interface for displaying data to the user, and accepting input from the user. The business logic implements business rules, e.g., data validation and task-specific behavior. The data access logic controls database communication, e.g., constructing SQL queries and executing them with an API.

The presentation layer 202 includes component scripts 212, dialog type scripts 214, screen structures 216, extensible markup language (XML) files 218, extensible style sheet language transformation (XSLT) process 220, extensible style sheet language (XSL) files 222, cascading style sheets (CSS) 224, and hypertext markup language (HTML) document output 226.

Instead of XML/XSL/XSLT being involved in the styling of the contacts networking application at the presentation layer, the styling is stored in mostly static template pages with dynamic components. For example, loops, conditional statements, etc. These template pages are fed into a templating engine that processes the dynamic components and then outputs an HTML document that is then sent to the client. A Templating Engine that works here is SMARTY, an open-source PHP software package designed to help developers separate application logic and content from presentation (see http://smarty.php.net).

The general flow from HTTP request (208) to HTTP response (210) is as follows:

(1) An HTTP request sent to the appropriate Workflow Engine;

(2) The workflow engine processes the information from the HTTP request, possibly funneling it through some number of utility and/or logic engines;

(3) Control passes back to the workflow engine which determines the next page to display based on feedback from the business layer engine;

(4) Workflow engine passes values to the templating engine;

(5) Templating Engine merges those values into a pre-defined template (HTML/CSS/JavaScript) which is sent as the HTTP response; and

(6) HTTP response is displayed on the client's browser.

The business layer 204 includes database table classes 228, abstract table classes 230, a validation class 232, and a collection of workflow, utility, and logic engines 234.

Three different types of engines are included with a contacts networking application. Workflow engines are used to manage a process, e.g., creating user accounts, campaigns, etc. Utility engines operate on data, e.g., validation, transformation for normalization, etc. Logic engines are used for complex operations or operations on large amounts of data. For example, an incentive engine is used to calculate incentives based on campaign activity. A tracking engine is used to deliver tracking statistics based on campaign activity.

Utility and logic Engines are best disposed within the business layer 204. Workflow engine act as intermediaries between the presentation and the business layers 202 and 204. The presentation layer is a good place to put them, however the exact placement is not important.

The data access layer 206 comprises a data manipulation language (DML) class 236, a database 238, and an audit class 240. In an embodiment that was prototyped, there was no audit class 240 included in the contacts networking application because PostgreSQL can automatically log all activity to the database. An audit log keeps track of the changes made to the database and by whom. Database table classes are included in the data access layer 206. Such call the Database Access Objects (DAO).

There is generally one DAO class per table, though there are exceptions. For example, when a database action spans multiple tables. The UsersDAO, for example, handle all interactions with the users table in the database, e.g., when retrieving information about an existing user or adding a new user to the table. Each DAO provides functions that may be called to perform operations on the tables that that DAO is responsible for. Since the actual SQL statements are hidden within the DAO functions, the client of the DAO is not required to deal with the specifics of the database driving the contacts networking application. The client simply needs to know what the function calls are named.

The presentation layer 202 includes a separate component script for each transaction or task to identify the models, views and controller components to use. A screen structure script identifies which XSL stylesheet to use for the HTML output, and lists field names with their associated labels. A dialog type script controller component manages the input request and generates the output response. It communicates with table objects in the business layer 204. Data from these objects is written out to an XML file 218 then converted into HTML output 226 by an XSL transformation process 220. The XML file is generated automatically by the dialog type script. It has the data obtained by the table classes and other data required by that component. The XSL stylesheet includes the commands which will transform the XML input into HTML output during the XSL transformation process. It is possible to create custom stylesheets. The XSL transformation process uses the XML input to transform it into HTML output using the rules defined within the XSL stylesheet. The HTML output text file is sent to the client's web browser. It is rendered into a viewable page with the assistance of CSS files 224. The CSS files are a way of specifying a standard style in a group of HTML documents.

The business layer 204 includes a separate table class for each database table or business entity. Each table class is a subclass of a generic table class so that it can inherit as much generic code as possible. All communication with the physical database 238 is handled by the generic table class through a separate DML class. Primary data validation is handled by the generic table class through a validation class. Secondary data validation is performed by customized functions within each table class. The business layer 204 communicates with Engines 234 to determine if a new workflow case needs to be created, and to progress each case through its various stages.

The data access layer 206 comprises DML objects 236 to communicate with the databases 238. A separate DML class is used for each database engine, e.g., MySQL, PostgreSQL, etc. Such are sometimes referred to as a Data Access Object (DAO). The same transactions can access tables in different databases, and tables through different database engines. The data Access layer 206 communicates with AUDIT class 240 to record changes made to an application database. A separate audit database can be reviewed later using online query screens.

Each component script 212 specifies the Model and View before handing control over to a particular controller. Dialog Type (controller) scripts 214 are Transaction Controllers or Page controllers. Each script is based on a particular combination of structure and behavior. The actual content is identified by the Screen Structure script 216 set in the calling Component script 212. Controller scripts may be called by many different component scripts 212. Each database table 238 (or business entity) is represented by its own class which extends the generic table class. Each table subclass will inherit all the generic code from the superclass. It includes information specific to the database table to which it relates. Generic (abstract) table class 230 is an abstract class because it does not include implementation details and cannot be instantiated into an object. Implementation details for each physical database table are supplied in separate subclasses, only these subclasses are instantiated into objects. Because this class/object exists in the Data Access layer 206 it may be referred to as a Data Access Object (DAO). This abstract database class contains generic methods and properties which can be used by any database table in the system. These methods and properties are automatically inherited by every subclass. Code specific to any particular table is built into in the subclass for that particular table. A generic validation class 232 handles primary validation of all user input, e.g., declarative checking. It compares the contents of the input array with the contents of the a $fieldspec array to verify that the input data for each field conforms to that field's specifications. It puts any error messages in a current object's $errors array. The DML class 236 is the only object in the system that communicates with the database 238. It receives requests from a Generic Table class. It generates an appropriate DML or SQL command. It then executes these commands by calling a relevant API for the database in question. Screen Structure (View) scripts 216 are scripts which identify the view or content for the output screen. Each one identifies the name of an XSL stylesheet and a list of table names, field names and field labels that will be used during the XSL transformation process to produce the HTML output. XML files 218 are flexible text formats based on an open standard maintained by the World Wide Web Consortium. They send the XSL transformation process all the data it needs to produce HTML output. XSL Stylesheets 222 help transform data in the XML file 218 into HTML output 226. XSL Transformation process 220 uses the contents of an XML document to transform it to another document, e.g., an HTML document. It uses rules included within an XSL stylesheet.

It is possible to send both the XML and XSL files to the client and have the transformation done within the client's browser. But this may be unreliable due to the different levels (sometimes nonexistent) of XML/XSL support in different browsers. It is much safer to perform the transformation in a single place (the web server) where the software is under the control of the web developer. This is known as a server-side transformation.

The http response 210 is the document sent back to the client's browser in response to an http request 208. Its content conforms to the (X)HTML specification supervised by the World Wide Web Consortium. CSS files 224 Cascading Style Sheets which convey all the styling information, e.g., fonts, colors, sizes, positioning, etc. Tags within each HTML document refer to a style by a class name, and the specifications for each of these classes are communicated within a CSS file. It is possible to change the style specifications for any tag in all documents simply by changing the specifications within a single CSS file. AUDIT class 240 detects all database changes and records them in a separate ‘audit’ database. These can be reviewed later using online query screens.

The engines 234 is actually a collection of engines that are tailored specifically for the business application. In one instance, it includes employer hiring incentives and email contact-tracking. Such allows different workflow processes to be defined. A triggering task and the sequence of subsequent tasks can be defined. A mechanism is included to automatically create a new workflow case when a triggering task is processed, then process that case through its various stages. For example, outstanding tasks in workflow cases which require human intervention will appear in a list to prompt the user to intervene. A task can be activated by clicking on its entry in such list.

Specifically, the email contact-tracking engine includes an embedded email address book manager. A “viral” forwarding functionality permits real time referral tracking for all responses, and two-way online communication with the campaign administrator or referral agent. A directory service is included to locate current email addresses of associates. The database can be used for resume storage and handling. In some embodiments of the present invention, it may be necessary to limit email messages to intra-company email, or open it up to non-employee recipients. Auto non-duplicate email detection and handling would also be advantageous.

The contacts networking technology system 100 facilitates and maximizes employee and member referral and recruitment programs, e.g., incentive automation. Users can create their own personal email message or incentive challenge campaigns with just a few “clicks” at their browser. For example, an employer could incentivize their employees to search their current social and business network base by offering a direct $1000 cash bonus or charitable contribution for any employee who finds a new hire for the company through their contacts list.

Contract recruiters can broadcast employment opportunities that they are unable to fill, and agree to offer an incentive or finder's payment with the recipients. Sales managers can expand in-house CRM contacts' databases for key target accounts.

The combinations of incentive units (dollars, days off, points, etc.) can be defined by the employer. Such ability allows each participant to personalize the incentive, and this can spur healthy competition.

Email messages sent by users are personal, dynamic, actionable and customizable rich-text HTML emails. These can include graphics, animation files, colors, and incentive matching capabilities. Users can create personalized announcements or incentives for recruitment, fundraising or advocacy campaigns.

In some embodiments of the present invention, the email addresses of former co-workers or other business contacts can be looked up in a sort of directory assistance from a database containing millions names.

For the incentive engine, the incentives should be configurable in dollars, points or any other “units”. An employer can award a one-time direct bonus, e.g., to the referral agent who was directly responsible for referring the new hire. Some embodiments of the present invention can assist reporting income with IRS form 1099. Merchant accounts tracking and record-keeping administration can be included for donations made to a 501(c)3 not-for-profit organization.

Personal profiles include career and social/business networks. Each time an employee, friend, recruit or associate sets up a message campaign or responds to a message, they do so from their own personalized account using their personal email address as their user identification. Users track their personal campaign progress via their personal account. Users may also indicate their vocational fields of interest, e.g., to help customize the types of staffing positions they would like to be presented with during recruitment campaigns.

Users may upload and store resumes in their own personal account. When they apply for any job position, their resume and a corresponding employer job ID number and job title will automatically be attached. Users may store multiple resumes and select the desired resume to attach when responding to a particular job opening.

User identification and email addresses should never be sold, traded, or otherwise disclosed to a third party, other than to the entity receiving the donation or commitment unless the user has requested anonymity.

An embedded address book allows users to easily build, manage, and import existing contact lists from most standard email programs. This also guarantees delivery through most “spam” filters.

Anyone initiating a campaign message can view a visual referral contacts network (VRCN) map of their current referral network. Such VRCN map is a graphical display of the relationship structure between the current responders to each campaign. Administrators can view the responder relationship structure for the entire campaign. Champions have viewing access to only those respondents within their personal network circle.

Employer administrators can track the progress of all campaigns that they initiated as well as any branching campaigns sent by recipients, and track email addresses of respondents. Administrators can track the number of participants interacting, including the number of forwarded, branching and bounced emails.

In another embodiment, the networking technology system 100 platform accelerates the recruitment of clinical trial patents or sites and candidates, and strengthens sponsors' physician, patient and advocate relationships.

Setting up a campaign is quick and simple. A user first creates a campaign. All messages are issued by providing a campaign name and a brief profile of the trials protocol, and it indicates the primary purpose of the campaign. Such user establishes the start and end dates of the campaign. All campaigns must have a start date, however campaigns can be open-ended with no ending date. Sponsors assign administrative access to patient or support group staff to administer fundraising or volunteer/advocacy campaigns independent of any site or patient recruitment messaging.

If the sponsor wishes to include a bonus to encourage membership or volunteer recruitment, they may want to have access to the system's incentive functionality. They select a rule from standard challenge rules provided, and then define its parameters on a separate screen. Incentive methods include a direct bonus, where a one-time bonus is awarded for fulfilling the campaign goal. The referral agents can also share the bonus. Users may elect to share all or part of the provided bonus with their contacts as an incentive for participating in the campaign. For example, a company can decide to challenge and incentivize their recipients by agreeing to donate $5000 to charity if at least 100 qualified candidates sign up and participate in the trial campaign. If the sponsor wants to motivate potential site coordinators to sign up or to forward the recruitment message on to their professional contacts, they would use the same process.

Recipients have the opportunity to sign up, personalize and forward the message to their own list, or ask a question to the campaign administrator regarding any questions they may have before committing. Users can track all responses from within their personal accounts.

An alternative viewing method can be provided at the top of each message, e.g., for those recipients who are unable to read HTML emails. A hot link to a sponsor's homepage can also be included in the email.

When a recipient first responds in any way, they must set up a personalized account using their own email address as identification. That way a tracking engine can follow their contact referrals and build corresponding contact hierarchies.

Pre-approved personal accounts can be created if the organization passes the appropriate user information to the contacts networking application. The system actively tracks who has responded to which champion, and relaying that information to the administrator or sponsor for campaign reconciliation. Sponsors can capture valuable patient profiles for further contacts.

After recipients register for their own account, they are able to participate in campaigns by creating their own new challenge or invitation, make commitments, donations, appointments, or fulfill the champion's request.

Tracking can be done at multiple levels. One for each individual user, and another in aggregate for the campaign sponsor or administrator. Organization or sponsor administrators can track the progress of all loyalty campaigns initiated, as well as any branching campaigns sent by recipients, and track email addresses of respondents. All administrative control/access is controlled by the sponsor. The administrator can terminate any current campaign so that no other enrollments will be accepted if a goal or deadline has been met.

Each time an employee, friend, recruit or associate sets up a message campaign, or responds to a message, they do so from their own account using their email address as user identification. Users can track their personal campaign progress at any time via their personal account. Users may also indicate their vocational fields of interest to help customize the types of staffing positions they would like to be presented with during recruitment campaigns.

Users may upload and store their resumes in their own personal account. When they apply for any job position within the contacts networking application, their resume along with the corresponding employer job ID number and job title, will automatically be attached for them. An embedded address book technology allows users to build, manage, and import existing contact lists from most standard email programs. This also guarantees delivery through most “spam” filters.

Anyone initiating a campaign message can view a visual contacts network map of their current referral network. This visual referral contacts network (VRCN) map is a graphical display of the relationship structure between the current responders to each campaign. Administrators can view the responder relationship structure for the entire campaign, whereas champions will have viewing access to only those respondents within their personal network circle.

Employer administrators can track the progress of all campaigns that they initiated as well as any branching campaigns sent by recipients, and track email addresses of respondents. Administrators can track the number of participants interacting, including the number of forwarded, branching and bounced emails.

An employer, recruiter, or sponsor sets up their campaign including campaign name, duration, position description or marketing message, and any optional incentive specifications. The administrator also establishes the start and end dates of the campaign. All campaigns must have a start date, however specifying a corresponding end date is optional (campaigns can be open-ended).

If the employer wishes to include an bonus to encourage membership recruitment, they may want to have access to the incentive functionality. A rule is selected from standard challenge rules provided, and then they define its parameters. Incentive methods include direct, shareable, matching, group, and early completion bonuses. In a direct bonus, a one-time payment is awarded to the person directly responsible for fulfilling the campaign goal. Referral agents can be designated to share the bonus, users may elect to share all or part of the provided bonus with their contacts as incentive for their campaign participation.

Incentives can be structured by the sponsor/administrator in various units and amounts, e.g., numbers of dollars, hours of time off, points, coupons, volunteer hours, etc.

Users can become referral agents with just a few clicks. Contacts networking technology system 100 includes individual account access, embedded address book, and real-time tracking of messages. Each time an employee, friend, peer, or associate responds in any way, they are required to setup an account using their personal email address as their user identification.

Users may also indicate their vocational fields of interest to help customize the types of staffing positions they would like to be presented with during recruitment campaigns.

Contacts networking technology system 100 also allows users to search for email addresses of former co-workers or other business contacts, e.g., from a database containing over twenty million names.

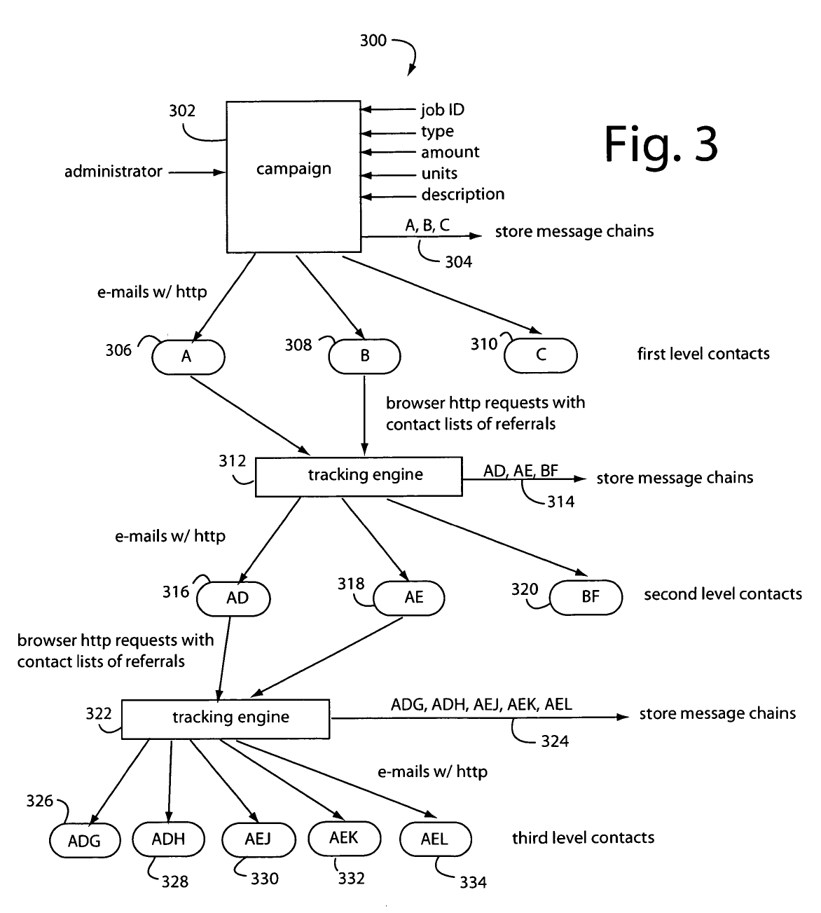

FIG. 3 represents a campaign contact-tracking method embodiment of the present invention, and is referred to herein by the general reference numeral 300. Method 300 begins with the creation of a job recruitment campaign 302. An administrator authorizes the campaign and supplies job ID, type of incentive, reward amount, reward units, and a description of the job. Campaign 302 decides who in its contact lists are suitable to receive notices by email. In this case, it is first level contacts A, B, and C. If any of these contacts ultimately is responsible for filling the job, then they would receive 100% of the incentive. There can be multiple incentives attached to one campaign. Emails with http hyperlinks back to system 100 are sent out to contact-A 306, contact-B 308, and contact-C 310. If any of them want to participate by referring others, each clicks on their embedded http hyperlinks which will issue http requests 208 (FIG. 2) to a tracking engine 312. Such is one example of an engine included in engines 234 (FIG. 2).

Tracking engine 312 generates a report 314 for the incentive engine documenting the second level contacts referred by the first level contacts. Here, for example, contact-A has referred a contact-D (AD) 316, and a contact-E (AE) 318. Contact-B has only referred one other, a contact-F (BF) 320. Contact-C 310 has not yet made any referrals, but could at a later date. The hierarchies are built-in to the message chains, AD, AE, and BF. Hierarchy daughters D and E have parent A. Hierarchy daughter F has only B as a parent.

These second level contacts can, in turn, make campaign referrals to a third level of contacts. The details of the campaign and its incentives are included in the email or in a webpage that can be accessed. The tracking engine needs to keep track of all referrals so the incentives can be distributed properly. If any of them want to participate by referring others, each clicks on their embedded http hyperlinks included in the emails they received from tracking engine 312. These clicks too will issue http requests, but this time to a tracking engine 322. Such is the same tracking engine as tracking engine 312, but it has a different element number in FIG. 3 to represent its operation at a later time.

Tracking engine 322 reports the third level contacts in a report 324. Here, A referred D and E. Contact-D, in turn, referred G and H. Contact-E, in turn, referred J, K, and L. Contact-F, so far, has not referred anybody. These are represented in FIG. 3 as Contact-G (ADG) 326, contact-H (ADH) 238, contact-J (AEJ), contact-K (AEK) 332, and contact-L (AEL) 334.

In the example illustrated by FIG. 3, reports of referral contacts have been recorded for A, B, C, AD, AE, BF, ADG, ADH, AEJ, AEK, and AEL. If the job was ultimately filled by the efforts of Contact-J 330, it could be inspected easily from report AEJ that contact-A 306 and contact-E 318 will also be sharing in the incentives. The split between them that they qualify for was set originally by the administrator or employer in campaign 302. It could be equal shares, graduated, challenge-matched, or structured in any number of ways. Hierarchies can be limited, e.g., up to five levels, because the incentive shares can become de minimus with too many levels. For example, a $1000 incentive split five ways would be $200. Less than that is not much incentive for an individual. Such limits are enforced by the tracking engines 312 and 322, and dictated by the campaign 302.

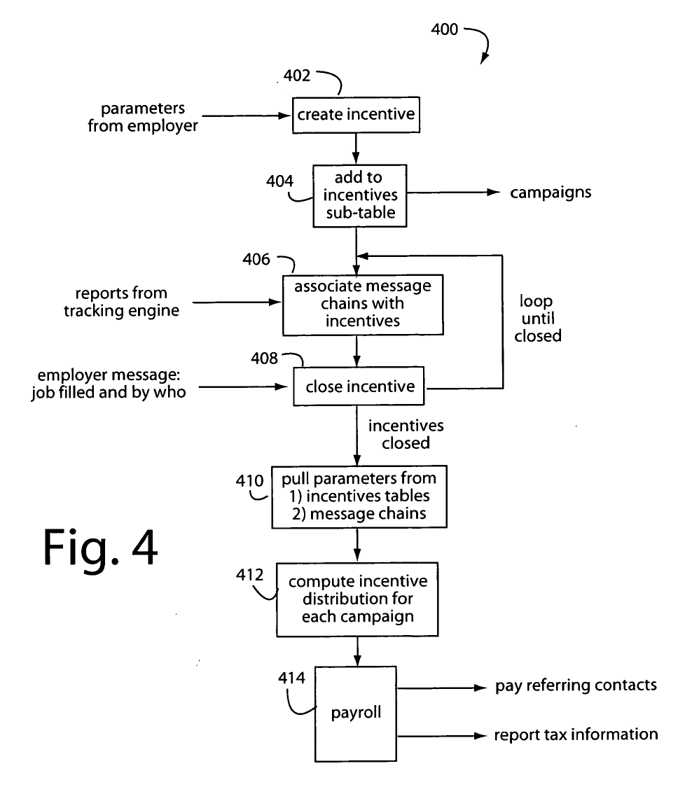

FIG. 4 represents an incentive engine embodiment of the present invention, and is referred to herein by the general reference numeral 400. When a campaign ends because a job has been filled, the incentive engine 400 is called in to compute who gets what shares. Job opportunities can be created and listed, but they do not necessarily ever have to be made the subject of an incentive campaign. But when they are, the creation of the campaign generates several parameters that will be needed by incentive engine 400 to compute the payments due. The sponsor or administrator issues an http request by opening a management web page from a client browser. A web page is presented that collects the campaign and job ID, and who made the final placement.

Specifically in one embodiment, the incentive engine 400 comprises a step 402 that creates individual incentives that are associated with a job ID. Various parameters are received from the employer, e.g., in http requests from an employer's browser or emails. A step 404 adds this incentive to a sub-table of incentives. Such is then made available to campaigns, as in FIG. 3. A step 406 receives reports from tracking engines that assist in building message chains. The contacts in these chains are associated with the incentives the respective campaigns involved them in. A step 408 loops back to associate more reports from tracking engines until a message is received from the employer that the job has been filled and which contact succeeded at the recruiting. Thereafter, the incentives are closed. This triggers a step 410 to pull all the incentive and message chain parameters for an incentive engine algorithm. A step 412 computes from these parameters how much of what each referring contact gets, and if challenges to match or donate have ripened. A step 414 computes the payroll and issues paychecks and IRS returns.

Embodiments of the present invention strictly enforce the privacy rights of their users. Tracking engines 312 and 322 are in a strategic location in the system 100 that allows for such privacy controls. User identification and email addresses must never be unintentionally or in an unauthorized way made visible, sold, traded, or otherwise disclosed to a third party.

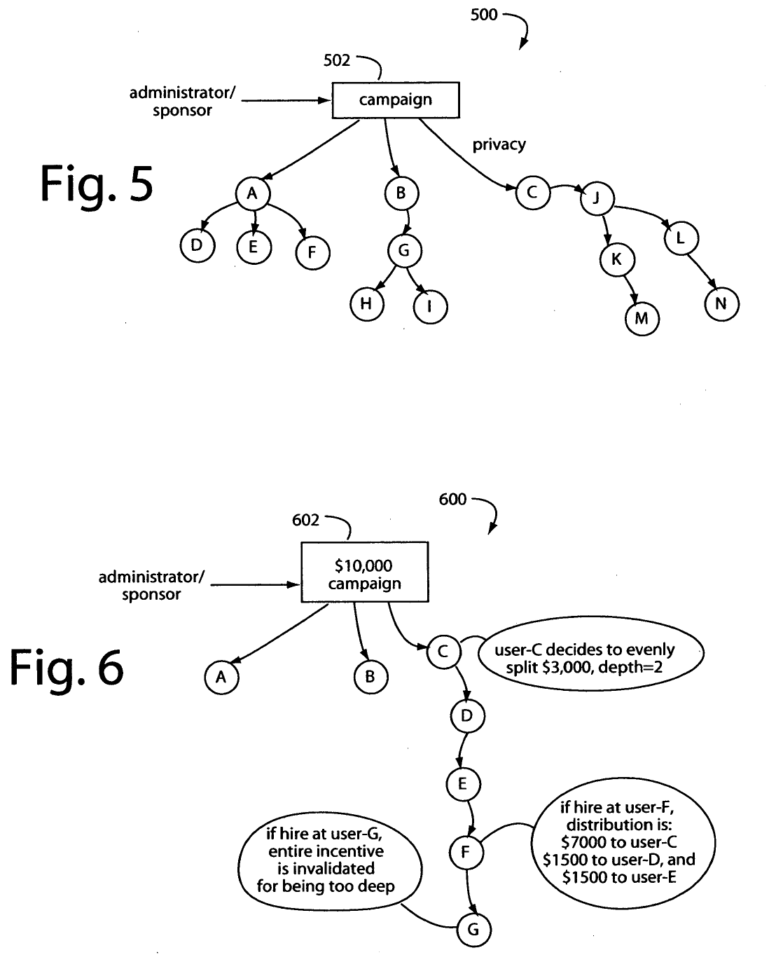

FIG. 5 diagrams a privacy process 500. Here, a campaign 502 has a sponsor/administrator that initiates the activity. Similar to FIG. 3, a first level of contacts includes user-A, user-B, and user-C. For example, in a first privacy strategy, user-A chooses to hide their referrals and contacts from the sponsor/administrator. The identities of user-D, user-E, and user-F may be hidden and each only referred to by some code number. In a second privacy strategy, a user-G chooses to hide the identities of downstream referral contacts from the upstream referrer user-B. But the administrator/sponsor still has visibility to user-H and user-I. User-j can hide the recipients from future referrers. When user-K views the tracking for the campaign, the identity of user-L and everyone downstream of user-L is hidden. When user-L views tracking, the identity of user-K and everyone beneath user-K is hidden.

Individual account controls allow for multi-level administration. The sponsors can allow users along a chain to elect to share their bonuses. The number of layers in a chain allowed to share can be fixed. The sponsors can configure their incentives in any amounts and in any kind of units. Bonuses can be customized to particular individuals or groups. Bonus types selectable by the sponsors include direct-fixed, shareable, matched by third parties, outstanding contribution received, outstanding group participation, early completion, etc. Each incentive can be constructed as a combination of any or all of these.

FIG. 6 illustrates an incentive process 600. For example, a campaign 602 is worth $10,000 for the successful placement of a candidate for a job. the campaign is communicated to user-A, user-B, and user-C. User-C elects to share $3000 of the bonus to a maximum depth of two. User-C refers to user-D, who refers to user-E, and they refer to user-F. If the hire is made at user-F level, then user-C will get $7,000, and users D and E will split the remaining $3000. If the hire is made at a user-G level, the entire incentive evaporates because user-C set the maximum depth at two.

Employees, or others who the recruiting organization wants to have access to openings, can receive a message from the recruiter, or a current user, or access openings powered by browsing public or the recruiter's private label job boards.

Recipients of referral messages can respond in at least three ways. They have the option to attach their resume and apply for the job themselves, they can personalize and forward the message to other qualified or interested candidates from their contacts list, or can automatically refer a candidate of their choice to the campaign administrator.

Users may also upload and store their resumes in their own personal account. When they apply for any job position within the contacts networking technology system 100 application, their resume along with the corresponding employer job ID number and job title, will automatically be attached for them. Users may store multiple resumes and then select the desired resume to send when responding to a job opening.

The PHP implementation described above can, instead, be implemented as an active server page (ASP). ASP's are a traditional specification for a dynamically created Web page with a .ASP extension that uses ActiveX scripting, e.g., usually VB Script or Jscript code. When a browser requests an ASP, the Web server generates a page with HTML code and sends it back to the browser. ASP's are similar to CGI scripts, but they enable Visual Basic programmers to work with familiar tools.

Contacts networking application embodiments of the present invention support at least two types of privacy. These can be implemented as engines 234 (FIG. 2). A recipient list privacy engine protects the identity of a user's target audience from at least one of a campaign administrator, previous referrers in a chain, and future referrers in such chain. A response privacy engine provides for the anonymity of a campaign participant, e.g., preventing their identity from becoming known to at least one of a campaign administrator, previous referrers in a chain, and future referrers in such chain.

Contacts networking application embodiments of the present invention may further include an intelligent incentive engine for recognizing when an incentive can no longer be applied to a campaign. It then intervenes in the messaging process to make users aware such incentive has been dissolved. A dynamic incentive engine can provide for modifications of the incentives within a campaign, such that administrators may increase, reduce, or completely remove incentives from even an active campaign.

An external interface so external applications can exchange data with the contacts network is very useful. For example, if an employer designates certain companies that they wish to receive referrals from, the contacts networking application can view those criteria and return referral agents who work for the designated companies and have opted-in to receive job solicitations. Another interface should provide for the direct posting of existing jobs to the contacts network application through a standardized XML format, e.g., HR-XML. It would also be desirable to include an HTML-based framework that allows administrators to customize the look-and-feel of their campaign messages.

In a very different embodiment, a commercial business like Safeway Groceries owns the contacts networking system. It also owns and maintains a list of shoppers' emails and other data. When various jobbers, distributors, and suppliers wish to run specialized promotional campaigns targeting particular shopper demographics, the commercial business sends out incentives like coupons and offers of special discounts. E.g., for purchases of certain products, in certain quantities, in certain time frames, or in certain combinations. A business like Safeway has loyalty programs that can be tied in to make these offers, either electronically or as hardcopy printed at the checkstands.

Although particular embodiments of the present invention have been described and illustrated, such is not intended to limit the invention. For example, the embodiments illustrated here have shown a job recruitment incentive contacts network. Modifications and changes will no doubt become apparent to those skilled in the art, and it is intended that the invention only be limited by the scope of the appended claims.

The invention claimed is:

1. A contacts networking system, comprising:
a webserver for receiving http requests from a plurality of client browsers and for answering them with http responses;
a campaign controller for accepting incentive programs and for issuing emails to a plurality of first level of contacts inviting them to help or to supply referrals to a second level of contacts, wherein said emails include hyperlinks to connect back to the webserver for a webpage to enter said second level of contacts;
a tracking engine for responding to said hyperlinks by collecting email addresses of a plurality of second level contacts supplied by individual ones of said first level contacts, and for issuing emails to said second level of contacts inviting them to help or to supply referrals to a third level of contacts, wherein said emails include hyperlinks to connect back to the webserver, and for reporting message chains that describe which contacts have referred other contacts; and
an incentive engine for distributing incentives to particular said contacts according to parameters extracted from said incentive programs and said message chains.

2. The system of claim 1, further comprising:
a plurality of clients with browsers that have email addresses identified in one of said pluralities of contacts; and
an enrollment process included with the webserver for registering individual ones of said contacts if not already enrolled by directing them to a particular webpage.

3. A campaign controller, comprising:
means for accepting incentive programs and for issuing emails to a plurality of first level of contacts inviting them to participate and be rewarded in a job recruitment, or to supply referrals to a second level of contacts, wherein said emails include hyperlinks to connect back to a webserver for a webpage to enter said second level of contacts.

4. A campaign controller, comprising:
means for accepting incentive programs and for issuing emails to a plurality of first level of contacts inviting them to donate an item, or to supply referrals to a second level of contacts, wherein said emails include hyperlinks to connect back to a webserver for a webpage to enter said second level of contacts.

5. A tracking engine, comprising:
means for responding to said hyperlinks by collecting email addresses of a plurality of second level contacts supplied by individual ones of a first level contacts, and for issuing emails to a second level of contacts inviting them to help or to supply referrals to a third level of contacts, wherein said emails include hyperlinks to connect back to a webserver, and for reporting message chains that describe which contacts have referred other contacts.

6. An incentive engine, comprising:
means for distributing incentives to particular a contacts according to parameters extracted from published incentive programs and message chains related to a hierarchy of contacts referring other contacts through a registered process managed by a webserver.

7. A contacts networking system, comprising:
a webserver for receiving http requests from a plurality of client browsers and for answering them with http responses;
a campaign controller for accepting incentive programs and for issuing emails to a plurality of first level of contacts inviting them to help or to supply referrals to a second level of contacts, wherein said emails include hyperlinks to connect back to the webserver for a webpage to enter said second level of contacts;
a tracking engine for responding to said hyperlinks by collecting email addresses of a plurality of second level contacts supplied by individual ones of said first level contacts, and for issuing emails to said second level of contacts inviting them to help or to supply referrals to a third level of contacts, wherein said emails include hyperlinks to connect back to the webserver, and for reporting message chains that describe which contacts have referred other contacts;
an incentive engine for distributing incentives to particular said contacts according to parameters extracted from said incentive programs and said message chains;
means for individual account access for each participant;
means for automated incentive creation and management;
an embedded email address manager with viral forwarding functionality and ability to automatically refer a candidate;
means for resume storage and handling;
a directory service for locating current email addresses of persons known to said contacts;
means for real time referral tracking for all responses;
means for multi-level organization administration; and
means for automatic non-duplicate email detection and handling.

8. The system of claim 7, wherein:
the incentive engine is implemented as a logic engine within a PHP application.

9. The system of claim 7, wherein:
the tracking engine is implemented as a logic engine within a PHP application.

10. A contacts networking system server, comprising:
a campaign controller for accepting incentive programs and for issuing emails to a plurality of first level of contacts inviting them to help or to supply referrals to a second level of contacts, wherein said emails include hyperlinks to connect back to a webserver for a webpage to enter said second level of contacts;
a tracking engine for responding to said hyperlinks by collecting email addresses of a plurality of second level contacts supplied by individual ones of said first level contacts, and for issuing emails to said second level of contacts inviting them to help or to supply referrals to a third level of contacts, wherein said emails include hyperlinks to connect back to the webserver, and for reporting message chains that describe which contacts have referred other contacts; and
an incentive engine for distributing incentives to particular said contacts according to parameters extracted from said incentive programs and said message chains.

11. The contacts networking system server of claim 10, further comprising:
a recipient list privacy engine for protecting the identity of a contact's target audience from at least one of a campaign administrator, previous referrers in a chain, and future referrers in said chain.

12. The contacts networking system server of claim 10, further comprising:
a response privacy engine providing for the anonymity of a campaign participant, wherein their identity is prevented from being known to at least one of a campaign administrator, previous referrers in a chain, and future referrers in said chain.

13. The contacts networking system server of claim 10, further comprising:
an intelligent incentive engine for recognizing when an incentive can no longer be applied to a campaign and intervenes in a messaging process to make users aware of said incentive is dissolved.

14. The contacts networking system server of claim 10, further comprising:
a dynamic incentive engine providing for modifications of incentives within a campaign, and such that administrators may increase, reduce, or completely remove incentives from an active campaign.

15. The contacts networking system server of claim 10, further comprising:
an interface providing for external applications to exchange data with the contacts network.

16. The contacts networking system server of claim 10, further comprising:
an interface providing for a direct posting of existing jobs to the contacts network application through a standardized XML format (HR-XML).

17. The contacts networking system server of claim 10, further comprising:
an HTML-based framework providing for administrators to customize the look-and-feel of their campaign messages.
